(19) United States
(12) Patent Application Publication
(10) Pub. No.: US 2006/0058405 A1
(43) Pub. Date: Mar. 16, 2006

(54) Molded foams

(75) Inventors: Gabor Felber, Veszprem (HU); Robert A Grigsby JR., Austin, TX (US); Ernest L Rister JR., Round Rock, TX (US); Robert L Zimmerman, Austin, TX (US)

Correspondence Address: Legal Department;Huntsman, 7114 North Lamar Blvd, Austin, TX, 78752, US

(73) Assignee: Huntsman Petrochemical Corporation, Austin, TX (US)

(21) Appl. No.: 10/535,725

(22) PCT Filed: Dec. 2, 2003
(86) PCT No.: PCT/US03/38057

§ 371 Date: May 20, 2005

Related U.S. Application Data
(60) Provisional application No. 60/430,928, filed on Dec. 4, 2002.

(51) Int. Cl. C08J 9/00

(52) U.S. Cl. 521/99

(57) ABSTRACT

Provided herein are catalyst combinations and processes useful for producing polyurethane foam products which have a greatly lessened tendency to emit vapors of residual amounts of catalysts, after prolonged storage of the foams even at elevated temperatures. According to one form of the invention, a reactive catalyst is used in combination with a polyol precursor wherein the polyol precursor has an unsaturation level that is below about 0.030 meq./g.

### CROSS REFERENCE TO RELATED APPLICATIONS

This application claims priority to U.S. provisional Application Ser. No. 60/430,928, Filed Dec. 4, 2002, and is a § 371 of PCT/US03/038057.

### FIELD OF THE INVENTION

This invention relates to catalysts useful in producing polyurethane foams. The invention also relates to processes for manufacturing polyurethane foams. A foam produced in accordance with the teachings of the present invention has a greatly reduced propensity towards emitting vapors of residual catalyst after it has cured while still retaining a high level of performance characteristics.

### BACKGROUND

Molded foams prepared using conventional catalysts (fugitive amine catalysts) have been known for quite some time. However, with recent new concerns about the emission of volatile organics from finished foam products such as automotive interior parts like dashboards, seats, and trim, many foams made using prior art chemistry and processes are becoming unacceptable because of the emission of residual amounts of the amine catalysts used in their manufacture. One solution proposed by those skilled in the art has led to attempts to employ reactive catalysts, i.e., those which are chemically reacted during the curing process with the thought being that if the catalyst is reacted, then it is not possible for it to be emitted from the finished foam product. Unfortunately, thus far such attempts have resulted in foams having physical properties which are unacceptably low in performance terms for their intended use. Thus, finding catalysts which do not volatilize after a foam is in place in its final manufacture, which catalysts also produce foams having acceptable performance properties, is a currently problem at the forefront of the polyurethane foam art.

Huntsman's new non-reactive catalyst JEFFCAT® Z-140 helps to prevent losses in performance known to occur when reactive catalysts are used, and this catalyst and its use is described in the disclosure in U.S. Pat. No. 6,458,860. While JEFFCAT® Z-140 catalyst helps to minimize emissions from a cured foam, foams formed using the JEFFCAT® Z-140 catalyst may still not meet some of the newer emission requirements in the future, should such requirements become more stringent. Another patent document, U.S. Pat. No. 5,010,117 describes the use of polyols having low levels of unsaturation to improve the processing and compression set values of the foams so produced.

The present invention solves the problem of molded foams which require both low amine emission from the finished foam after curing, and a high performance level of physical properties. Such foams are required by the automotive industry.

### SUMMARY OF THE INVENTION

We have surprisingly found that polyurethane foams prepared using polyols having a low level of unsaturation in the presence of reactive amine catalysts enables us to overcome the issue of the emission of residual amines from polyurethane foams, while still maintaining the satisfactory physical properties of the finished foams, such as wet and humid-aged compression set values.

The present invention provides a process for producing a polyurethane foam comprising the steps of: a) providing an organic polyol having a molecular weight in the range of 2000 to 7000, wherein the polyol has a level of unsaturation of between 0.001 and 0.030 meq./gram; b) providing an organic isocyanate; c) providing a blowing agent; d) providing a reactive catalyst; e) mixing the polyol, isocyanate, and the blowing agent in the presence of the catalyst, so as to produce a polyurethane foam.

### DETAILED DESCRIPTION

The present invention comprises the manufacture of polyurethane foams using reactive catalysts and high molecular weight polyols that are possessed of very low levels of unsaturation as raw materials. A polyurethane foam prepared according to the present invention may includes all foams known, including: flexible foam, HR foam, semi-rigid foam, rigid foam, microcellular foam, and elastomer foams which are prepared by the conventional known one-shot method, or the pre-polymer method. Thus, the words “polyurethane foam” as used herein includes all of the aforesaid foam types. Among these known processes, particularly preferable is the process for producing polyurethane foam by using a foaming agent which is processed in a combined form such as foil, coating, or border material, or by molding integratedly, with other materials. These “other materials” include without limitation resins such as polyvinylchloride resin, ABS resin, polycarbonate resin, etc., metals, and glasses. Examples of applications of the final foam product include interior articles of automobiles such as instrument panels, seats, head rests, arm rests, and door panels as well as packaging materials.

Polyurethane foam is usually produced by a process which comprises the steps of: a) providing an organic polyol having a molecular weight in the range of 2000 to 7000 and a level of unsaturation of less than 0.10 meq./gram; b) providing an organic isocyanate; c) providing a blowing agent; d) providing a reactive catalyst; and e) mixing the polyol, the isocyanate, and the blowing agent in the presence of the catalyst, so as to produce a polyurethane foam. Various possible equipment configurations useful in conjunction with carrying out such steps to produce a foam are known in the art. Polyols useful in providing a polyurethane foam according to the present invention include polyetherpolyols, polymer polyols, and polyesterpolyols having 2 or more reactive hydroxyl groups. Polyetherpolyols include, for example, polyhydric alcohols such as glycol, glycerin, pentaerythritol, and sucrose; aliphatic amine compounds such as ammonia, and ethyleneamine; aromatic amine compounds such as toluene diamine, and diphenylmethane-4,4′-diamine; and/or a polyetherpolyol obtained by adding ethylene oxide or propylene oxide to a mixture of above-mentioned compounds. Polymer polyol is exemplified by a reaction product of said polyetherpolyol with ethylenic unsaturated monomer, such as butadiene, acrylonitrile, and styrene, the reaction being conducted in the presence of a radical polymerization catalyst. It is most preferable that a polyol used to prepare a foam according to the present invention has an unsaturation content of less than 0.03 meq./gram. According to an alternate form of the invention, the polyol used to prepare a foam according to the present invention has an unsaturation content of between 0.001 and 0.030 milliequivalents for every gram of polyol used in its manufacture. According to yet another alternate form of the invention, the polyol used to prepare a foam according to the present invention has an unsaturation content of between 0.005 and 0.025 milliequivalents for every gram of polyol used in its manufacture. According to yet another alternate form of the invention, the polyol used to prepare a foam according to the present invention has an unsaturation content of between 0.010 and 0.020 milliequivalents for every gram of polyol used in its manufacture. Thus, the words “organic polyol” as used herein includes any and all of the aforesaid polyols, including mixtures thereof.

As for the isocyanate or polyisocyanate component, all organic isocyanates or polyisocyanates known to those skilled in the art as being useful in preparing polyurethanes may be employed in a process according to the invention including, for example, aromatic polyisocyanates such as toluene diisocyanate, diphenylmethane-4,4′-diisocyanate, and positional isomers thereof, polymerized isocyanate thereof, and the like; aliphatic polyisocyanates such as hexamethylenediisocyanate and the like; alicyclic polyisocyanates such as isophoronediisocyanate and the like; pre-polymers with end isocyanate groups such as toluenediisocyanate pre-polymer and diphenylmethane-4,4′-diisocyanate pre-polymer which are obtained by the reaction of the above-mentioned substances with a polyol; denatured isocyanate such as carbodiimide denatured substances; and further mixed polyisocyanates thereof. Thus, the words “organic isocyanate” as used herein includes any and all of the aforesaid isocyanates, including mixtures thereof.

Blowing agents useful in accordance with the present invention are exemplified by low boiling point hydrocarbons such as butane, and pentane, halogenated hydrocarbons, carbon dioxide, acetone, and/or water. Known halogenated methanes and halogenated ethanes may be used as halogenated hydrocarbons. Among them, preferably, are chlorofluorocarbon compounds such as dichlorotrifluoroethane (R-123), dichloromonofluoroethane (R-141b), and the like. The amount of the foaming agent to be used is not particularly limited, but the amount of chlorofluorocarbon to be used is usually not larger than 35 parts by weight, preferably 0 to 30 parts by weight, based on 100 parts of polyol, and the amount of water to be used is not less than 2.0 parts, preferably 3.0 to 20.0 parts. Thus, the words “blowing agent” as used herein includes any and all of the aforesaid blowing agents, including mixtures thereof.

It is often the case that it is beneficial to include a foam stabilizer in the polyol portion of the polyurethane precursors. Such a stabilizer is selected, for example, from non-ionic surfactants such as organopolysiloxanepolyoxyalkylene copolymers, silicone-glycol copolymers, and the like, or a mixture thereof. Suitable silicone stabilizers include without limitation TEGOSTAB® B-4690 by Goldschmidt and DC-5043 by Dow Corning. The amount of the stabilizer is not particularly specified, but is usually about 0 to 2.5 parts by weight based on 100 parts by weight of polyol, as is known to those skilled in this art.

Reactive catalyst components useful as components in producing a foam according to the invention include, without limitation: JEFFCAT® DMEA, JEFFCAT® ZR-70, JEFFCAT® Z-110, JEFFCAT®ZF-10 (2-(2-(2-dimethylaminoethoxy-)ethyl methyl amino-)ethanol), JEFFCAT® ZR-50 (bis-(3-dimethylaminopropyl)-imino-propan-2-ol); JEFFCAT® DPA (2-propanol, (1,1′-((3-(dimethylamino)propyl)imino)bis-;), JEFFCAT® Z-130, (tetramethyliminobispropylamine), dimethylaminopropylurea, bis(dimethylaminopropyl)urea, or any material that is known to those skilled in the art as being capable of functioning as a blowing or gelling catalyst in a polyurethane system which contains three heteroatoms or active sights with two carbon spacing which is consumed during the formation of the foam. The most preferred catalysts are JEFFCAT®ZF-10, JEFFCAT® ZR-50, JEFFCAT® DPA, and JEFFCAT® Z-130. Thus, the words “reactive catalyst” as used herein includes any and all of the aforesaid catalysts, including mixtures thereof.

Non-reactive catalyst components useful as components in producing a foam include, without limitation: JEFFCAT® TAP, JEFFCAT® ZF-22, JEFFCAT® DD, tetramethylbutanediammine, dimorpholinodiethylether, JEFFCAT®MEM, JEFFCAT®MEM DM-70, JEFFCAT®MEM bis(dimethylaminoethoxy)ethane, JEFFCAT® NMM, JEFFCAT® NEM, JEFFCAT® PM, JEFFCAT® M-75, JEFFCAT® MM-20, JEFFCAT® MM-27, JEFFCAT® DM-22, Pentamethydiethylenetriamine, Tetramethylethylenediammine, Tertamethylaminopropylamide, 3-dimethylamino-N,N-dimethylpropylamide, or any material that is known to those skilled in the art as being capable of functioning as a blowing or gelling catalyst in a polyurethane system which is not consumed during the formation of the foam. Thus, the words “non-reactive catalyst” as used herein includes any and all of the aforesaid catalysts, including mixtures thereof. (JEFFCAT® is a registered trademark of Huntsman Petrochemical Corporation of Austin, Tex.) All of the foregoing JEFFCAT® trademarked materials are available from Huntsman Petrochemical Corporation, 7114 North Lamar Boulevard, Austin, Tex.

According to the present invention, other auxiliary agents may be added to the polyurethane precursors if necessary, and preferably to the polyol prior to its being contacted with the isocyanate. They include flame retardants, coloring agents, fillers, oxidation-inhibitors, ultraviolet ray screening agents, and the like known to those skilled in the art.

The amount of the amine catalyst used in a composition from which a foam may be produced in accordance with the present invention is in the range of from 0.02 to 10 parts, more preferably 0.1 to 5 parts, by weight based on 100 parts of the polyol. This includes any catalyst used. In addition, other known tertiary amine catalysts, organic carboxylic acid salts thereof, and organo tin compounds which are usually used as co-catalysts may be employed as auxiliary catalysts. In the process for producing polyurethane according to the present invention, polyols, polyisocyanates, and foaming agents, stabilizers, and if necessary, other auxiliary agents which are hitherto known, may be employed.

The Examples which follow are provided for the benefit of those skilled in the art to appreciate a working example of the principles embraced by the inventive concept. These examples are provided as being inseparably attached to the understanding that they are to be construed as exemplary, and not as delimitive of the invention in any way, shape, or form.

### EXAMPLES

In the examples which follow, two polyols were used—Polyol A (an ethylene oxide capped—propylene oxide adduct of glycerine with a hydroxyl number of 32.7 mg KOH/g and an unsaturation content of 0.0419 meq./g); and Polyol B (an ethylene oxide capped—propylene oxide adduct of glycerine with a hydroxyl number of 31.5 mg KOH/g and an unsaturation content of 0.0241 meq./g). Thus, Polyol A has a higher level of unsaturation than Polyol B. The unsaturation of the polyol is determined using mercuric acetate titration, as is well-known to those skilled in the art. All parts and percentages set forth in the present specification and appended claims are expressed on a weight basis.

These foams also contain either reactive or non-reactive catalysts. The non-reactive catalyst system is a blend of JEFFCAT® TD-33A, JEFFCAT®ZF-22, and JEFFCAT® Z-150 dissolved in nonylphenol ethoxylate. The reactive catalyst system is a blend of JEFFCAT® ZF-10 and JEFFCAT® ZR-50.

The foams of Examples 1-3 were made by premixing the polyol components together, 648.9 g, with the specified amount of catalysts, and then adding the isocyanate, 205.4 g (the isocyanate used is a 90/10 weight ratio of toluene diisocyanate and Rubinate® M, a polymeric isocyanate), and mixing for 6 seconds using a 3000 ppm stirrer. The mixture was then poured into a cubic shaped, 15 by 15 by 4-inch mold, which mold was pre-heated to 54°-57° C. After filling, the mold was closed and placed in the oven at 66° C. for 6 minutes. The foam sample was removed from the hot mold and crushed to open the cells of the foam. The foam was then placed into an oven at 66° C. for thirty minutes. Formulation, molding conditions, and physical properties for these foams are shown in Table I below:

| | Example No. | | |
|---|---|---|---|
| Component | 1 | 2 | 3 |
| Polyol A | 75 | 75 | — |
| Polyol B | — | — | 75 |
| ARCOL ® 3428 | 25 | 25 | 25 |
| Polymer Polyol | | | |
| Water | 2.5 | 2.5 | 2.5 |
| Diethanolamine | 1.275 | 1.275 | 1.275 |
| Silicon surfactant | 1.00 | 1.00 | 1.00 |
| JEFFCAT ® ZF-22¹ | 0.09 | — | — |
| JEFFCAT ® TD-33A² | 0.30 | — | — |
| Mixture of 33% (wt.) JEFFCAT ® | 0.30 | — | — |
| Z-150³ and 67% (wt.) | | | |
| SURFONIC ® N-95 | | | |
| JEFFCAT ® ZF-10 | — | 0.10 | 0.10 |
| JEFFCAT ® ZR-50 | — | 0.50 | 0.50 |
| Index | 1 | 1 | 1 |
| TDI/Polymeric isocyanate | 33.2 | 33.2 | 33.8 |
| (90/10 wt %) | | | |
| Molding conditions | | | |
| Temperature (° C.) | 54-57 | 54-57 | 54-57 |
| Mold fill time, (sec.) | 80 | 80 | 74 |
| Post cure at 66° C. (min.) | 30 | 30 | 30 |
| Physical Properties | | | |
| Molded properties | | | |
| molded density (kg/cm³) | 50.2 | 49.8 | 49.7 |
| core density (kg/cm³) | 46.4 | 44.4 | 44.6 |
| Humid Aged (5 hrs. @ 125° C.) | | | |
| ASTM 3574 | | | |
| Compression Set, 50% | 11.0 | 18.8 | 8.6 |
| Wet set⁴ | 16.7 | 30.7 | 16.8 |

¹70% (bisdimethylaminoethyl)ether and 30% dipropylene glycol
²33% triethylenediamine in dipropylene glycol
³(N,N-3-dimethylamino-)N′,N′-dimethylpropylamide
⁴50% compression set 22 hours at 49° C. and 100% relative humidity

Generally speaking, the foam of Example 1 was prepared using non-reactive catalysts and a polyol having a high level of unsaturation. The foam of Example 2 was prepared using reactive catalysts and a polyol having a high level of unsaturation. It is clear that the resulting foam from Example 2 has poor humid-aged properties. The foam of Example 3 was prepared using reactive catalysts and a polyol having a low lever of unsaturation in the polyol. The humid aged compression sets and wet sets are much better than example 2, but more importantly, they are about as good as or better than example 1, which is considered as the control sample.

TABLE II

| | Example No. | |
|---|---|---|
| Component | 4 | 5 |
| HYPERLITE ® E-851 | 10 | 10 |
| Polyol A | 90 | — |
| Polyol B | — | 90 |
| JEFFOL ® F-443 | 3 | 3 |
| water | 3.75 | 3.75 |
| Silicon Surfactant | 0.5 | 0.5 |
| JEFFCAT ® TD-33a | 0.51 | — |
| JEFFCAT ® ZF-22 | 0.10 | — |
| JEFFCAT ® ZF-10 | — | 0.10 |
| JEFFCAT ® ZR-50 | — | 0.60 |

Physical Properties

| | | |
|---|---|---|
| Humid Aged (5 hrs. @ 125° C.) ASTM 3574 | | |
| Wet set, as described for table I | 18.8 | 12.1 |

The foams in examples 4 and 5 were made on a two component high pressure impingement foam machine made by Hi-Tech Engineering of Grand Rapids, Mich. The pressure on the A and B precursor components of the polyurethane foam were set at 2000 psi. The A and B temperatures were held around 30° C. The throughput of the machine was set at 400 grams/second, and the shot time was adjusted to fill a 15 by 15 by 4-inch mold, which was pre-heated to 50° C. After filling the mold, the mold was closed and stuck back in the oven at 54° C. for 5 minutes. The foam sample was removed from hot mold and crushed to open up the cells of the foam. A 15-gallon flush of the next material was made in-between the runs run to clean the lines of old material.

As can be seen from examples 4 and 5, the humid aged compression sets of the foam having reactive catalysts and polyols with low levels of unsaturation perform better than the standard foam made from non-reactive catalysts and standard polyols with higher unsaturation.

TABLE III

| | Example No. | |
|---|---|---|
| Component | 6 | 7 |
| Polyol B | 75 | 75 |
| HYPERLITE ® E-851 | 25 | 25 |
| Water | 2.5 | 2.5 |
| Diethanolamine | 1.275 | 1.275 |
| Silicon surfactant | 1.00 | 1.00 |
| JEFFCAT ® ZF-22 | 0.09 | — |
| JEFFCAT ® TD-33A | 0.30 | — |
| Mixture of 33% JEFECAT ® Z-150 | 0.30 | — |
| and 67% SURFONIC ® N-95 | | |
| JEFFCAT ® ZF-10 | — | 0.10 |
| JEFFCAT ® ZR-50 | — | 0.50 |
| Index | 1 | 1 |
| TDI/RUBINATE ® M (90/10 wt %) | 33.51 | 33.51 |
| Molding conditions | | |
| Temperature (° C.) | 54-57 | 54-57 |
| Mold fill time, (sec.) | 75 | 70 |
| Post cure at 66° C. (min.) | 30 | 30 |

Physical Properties

| Molded properties | | |
|---|---|---|
| molded density (kg/cm³) | 49.9 | 50.4 |
| core density (kg/cm³) | 45.9 | 45.0 |
| Head space emission testing micro- | | |
| of carbon per gram of foam | | |
| amine components | 23.32 | 0.1 |

Examples 6 and 7 illustrate the advantages of having reactive catalysts in the foams. In these two examples, Bayer's HYPERLITE® E-851 which has a hydroxyl number of 20 mg KOH/g was used as the polymer polyol in place of ARCOL® 3428. Gas chromatography analysis of the head space showed that the amount of amine emission coming out of the foam from the reactive catalysts is essentially zero, which is a remarkable reduction over non-reactive catalysts. The head space emission testing was performed by sealing one gram of finished foam in a 22 milliliter glass phial and heated to 120° C. for 300 minutes. The carbon content of a one milliliter volume of the headspace from this container is then subjected to analysis by gas chromatography.

A foamed polyurethane prepared in accordance with the present invention may be carried out at any temperature in the range of between about 0 and 150° C. A foamed polyurethane prepared in accordance with the present invention may be carried out at any pressure in the range of between about 0.10 mm HG to 3 atmospheres.

Consideration must be given to the fact that although this invention has been described and disclosed in relation to certain preferred embodiments, obvious equivalent modifications and alterations thereof will become apparent to one of ordinary skill in this art upon reading and understanding this specification and the claims appended hereto. Accordingly, the presently disclosed invention is intended to cover all such modifications and alterations, and is limited only by the scope of the claims which follow.

What is claimed is:

1) A process for producing a polyurethane foam comprising the steps of:
a) providing an organic polyol having a molecular weight in the range of 2000 to 7000, wherein said polyol has a level of unsaturation of between 0.001 and 0.030 meq./gram;
b) providing an organic isocyanate;
c) providing a blowing agent;
d) providing a reactive catalyst;
e) mixing said polyol, said isocyanate, and said blowing agent in the presence of said catalyst,
so as to produce a polyurethane foam.

2) A process according to claim 1 wherein said reactive catalyst comprises one or more catalysts selected from the group consisting of: (2-(2-(2-dimethylaminoethoxy-)ethyl methyl amino-)ethanol); (bis-(3-dimethylaminopropyl)-imino-propan-2-ol); (2-propanol, (1,1′-((3-(dimethylamino)propyl)imino)bis-; and (tetramethyliminobispropylamine).

3) A process according to claim 1 wherein said isocyanate is an organic di-isocyanate.

4) A process according to claim 3 wherein said organic di-isocyanate is selected from the group consisting of: toluene diisocyanate, diphenylmethane-4,4′-diisocyanate, polymerized isocyanates; aliphatic polyisocyanates; alicyclic polyisocyanates; pre-polymers with end isocyanate groups such as toluenediisocyanate pre-polymer and diphenylmethane-4,4′-diisocyanate pre-polymer which are obtained by the reaction of the above-mentioned substances with a polyol; denatured isocyanate such as carbodiimide denatured substances; and further mixed polyisocyanates thereof. Thus, the words “organic isocyanate” as used herein includes any and all of the aforesaid isocyanates, including mixtures thereof.

5) A process according to claim 1 wherein said blowing agent is selected from the group consisting of: butane, pentane, halogenated hydrocarbons, carbon dioxide, acetone, and water.

6) A process according to claim 5 wherein said blowing agent comprises a halogenated hydrocarbon present in any amount between 2.0 and 30 percent by weight of the total polyol used in making said polyurethane foam.

7) A polyurethane foam which contains a level of unsaturation of between 0.001 and 0.030 milliequivalents for every gram of polyol used in its manufacture.

8) A polyurethane foam which contains a level of unsaturation of between 0.005 and 0.025 milliequivalents for every gram of polyol used in its manufacture.

9) A polyurethane foam which contains a level of unsaturation of between 0.010 and 0.020 milliequivalents for every gram of polyol used in its manufacture.

10) A polyurethane foam produced by a process comprising the steps of:
a) providing an organic polyol having a molecular weight in the range of 2000 to 7000, wherein said polyol has a level of unsaturation of between 0.001 and 0.030 meq./gram;
b) providing an organic isocyanate;
c) providing a blowing agent;
d) providing a reactive catalyst;
e) mixing said polyol, said isocyanate, and said blowing agent in the presence of said catalyst,
so as to produce a polyurethane foam.

11) A process according to claim 10 wherein said reactive catalyst comprises one or more catalysts selected from the group consisting of: (2-(2-(2-dimethylaminoethoxy-)ethyl methyl amino-)ethanol); (bis-(3-dimethylaminopropyl)-imino-propan-2-ol); (2-propanol, (1,1′-((3-(dimethylamino)propyl)imino)bis-; and (tetramethyliminobispropylamine).

12) A process according to claim 10 wherein said isocyanate is an organic di-isocyanate.

13) A process according to claim 12 wherein said organic di-isocyanate is selected from the group consisting of: toluene diisocyanate, diphenylmethane-4,4′-diisocyanate, polymerized isocyanates; aliphatic polyisocyanates; alicyclic polyisocyanates; pre-polymers with end isocyanate groups such as toluenediisocyanate pre-polymer and diphenylmethane-4,4′-diisocyanate pre-polymer which are obtained by the reaction of the above-mentioned substances with a polyol; denatured isocyanate such as carbodiimide denatured substances; and further mixed polyisocyanates thereof. Thus, the words “organic isocyanate” as used herein includes any and all of the aforesaid isocyanates, including mixtures thereof.

14) A process according to claim 10 wherein said blowing agent is selected from the group consisting of: butane, pentane, halogenated hydrocarbons, carbon dioxide, acetone, and water.

15) A process according to claim 14 wherein said blowing agent comprises a halogenated hydrocarbon present in any amount between 2.0 and 30 percent by weight of the total polyol used in making said polyurethane foam.
